(19) United States
(12) Patent Application Publication
(10) Pub. No.: US 2005/0065989 A1
(43) Pub. Date: Mar. 24, 2005

(54) Parallel infinite element method calculation system

(76) Inventors: Hiroshi Akiba, Tokyo (JP); Tomonobu Ohyama, Tokyo (JP); Masabumi Suzuki, Tokyo (JP)

Correspondence Address: BROOKS KUSHMAN P.C., 1000 TOWN CENTER, TWENTY-SECOND FLOOR, SOUTHFIELD, MI, 48075, US

(21) Appl. No.: 10/477,328

(22) PCT Filed: May 13, 2002
(86) PCT No.: PCT/JP02/04617

(30) Foreign Application Priority Data
May 14, 2001 (JP) 2001-142949

(51) Int. Cl. G06F 7/38

(52) U.S. Cl. 708/446

(57) ABSTRACT

The well known methods for a very large scaled structure problem, including domain decomposition method (DDM), DDM with Neumann preprocessing, BDD method and projected CG method, may involve problems that the divergence prevents from solving, and that the computation takes long time. The present invention provides a system of high potential computing performance for solving a very large scaled structure problem without divergence, with shorter computing time for a very large scaled structure problem of the degree of freedom of a million or more. The present invention comprises a parallel finite element method computing system for solving a very large scaled structure problem having the degree of freedom of one million (1,000,000) or more, comprising: a means for performing domain decomposition; a means for distributing a subdomain to a responsible part of each processor; a means for creating a rigid matrix; a means for defining overlapped movement of entire subdomain; a means for defining a default setting of projected CG method with preprocessing of all degree of freedom; a means for performing iterative computation of projected CG method with preprocessing of all degree of freedom; and a means for outputting a displacement solution, and a program for operating said system, and a computer readable recording medium having said program stored thereon.

### BACKGROUND OF THE INVENTION

1. Field of the Invention

The present invention relates to a very large scale parallel finite element method solver algorithm, which may effectively solve a very large scale structure problem of the degree of freedom of more than a million (1,000,000). More particularly, the algorithm incorporates a conjugate projected gradient algorithm of the domain decomposition, based on a parallel CG algorithm. The algorithm may be referred to as a “CGCG method (coarse Grid CG method)”: A space of the degree of freedom of subdomain level by the domain decomposition is referred to as a coarse space, and the subspace perpendicular to K is referred to as a fine space, where a stiffness matrix of the given structure problem is defined as K. The CGCG method may perform in parallel the conjugate projected gradient algorithm, adopting the k-orthogonal projection to the fine space for the projection.

2. Description of the Prior Art

The structural problem may be in general treated as follows: The objective structure in question is formulated as a continuum to define the dynamic equation of the continuum (equalizing equation in case of a static problem). It is almost impossible to solve this equation strictly. Rather the equation must be solved in such a manner as the numerical analysis. For this reason a reformulation of discrete proximity of the continuum problem is required. One of the solution proposed is the finite element method (computational dynamics handbook (I): finite element method for the structure, Japan Society of Mechanical Engineers, 1998) In the finite element method the space occupied by the continuum is at first decomposed to a plurality of elements (elements of the finite element method). Functions (form functions) having a domain with non-zero value localized to each element is then introduced to proximate to limit the continuum displacement field to expressions of the convolution of these functions. This may result in digitizing of the continuum displacement field and its motion equation (or equalizing equation). The digitizing allows the equation to decompose to a single linear equation (in case of a static linear problem) or a plurality of linear equations (for each incremental step in case of a non-linear problem; for each time step in case of dynamic problem). The degree of freedom (or dimension) treated by the linear equation is depending on the number of division of elemental decomposition of the continuous domain by the finite element method; the degree of freedom increases in general with the increase of the number of decomposition for better proximity, causing the difficulty of solving the corresponding linear equation.

The static structural problem of micro deformation may be decomposed to a linear problem on a product vector space in a finite dimension V given by the following equation (1)
Ku=F eq 1
where V designates to a space of permissible displacement field (vector field satisfying the boundary conditions of the displacement field), K to a stiffness matrix of the dimension dimV of V (symmetric when positive fixed set point), u to a variable vector of V, F to a constant vector of the KV≈V indicative of external force. The dimension dimV of V is equal to the number of the degree of freedom of the problem. The objective of the solver is to find a vector u, which satisfies the equation (1) above from within V.

Now the conjugate projected gradient algorithm (CPG: Conjugate Projected Gradient Algorithm: C. Farhat, F. X. Roux: Implicit Parallel Processing in Structural Mechanics, Computational Mechanics Advances 2, 1-124, 1994) will be described, which constitutes the base of the present invention. Consider a generic liner equation (eq. 2) of an inner product vector space V in a finite dimension:
Ku=F, u, FεV eq 2
where K is a linear transform of positive constant symmetry. One subspace Y of V is then selected. V is K-orthogonally projected to Y. A unique K-orthogonal projector P^{(Y)}, KP^{(Y)}=P^{(Y)}^{^{T}}K is determined. P^{(Y)}^{^{T}} is the transposition of P^{(Y)}. At this point a K-orthogonal projector P^{(a)} (auxiliary projector of P^{(Y)}), KP^{(a)}=P^{(a)}^{^{T}}K is uniquely determined, which satisfies the condition P^{(Y)}+P^{(a)}=1, the entire space V may be k-orthogonal direct sum decomposed to the image space Y, V^{(a)} of the P^{(Y)} and P^{(a)}, as given by equation (3):

$$V = Y ⊕ {V}^{( a )} , Y {⊥}_{K} {V}^{( a )} , ( \begin{matrix}Y \\ {V}^{( a )}\end{matrix} ) = ( \begin{matrix}{p}^{( Y )} \\ {p}^{( a )}\end{matrix} ) V \qquad eq 3$$

The K-orthogonality of P^{(Y)}^{^{T}}P^{(Y)} and P^{(a)} can be summarized as equation (4):

$$K ( \begin{matrix}{P}^{( Y )} \\ {P}^{( a )}\end{matrix} ) = ( \begin{matrix}{P}^{{( Y )}^{T}} \\ {P}^{{( a )}^{T}}\end{matrix} ) K \qquad eq 4$$

Therefore the linear equation eq. (2) can be decomposed to equation (5)

$$K ( \begin{matrix}{P}^{( Y )} \\ {P}^{( a )}\end{matrix} ) u = ( \begin{matrix}{P}^{{( Y )}^{T}} \\ {P}^{{( a )}^{T}}\end{matrix} ) F \qquad eq 5$$

Now the KY-component of F, P^{(Y)}^{^{T}}F and KV^{(a)}-component, P^{(a)}^{^{T}}F, or Y-component of u, P^{(Y)}u and V^{(a)}-component P^{(a)}u maybe independently processed. In brief, equation (2) can be K-orthogonally direct sum decomposed to two independent equations (6) and (7) with equation (8). For the sake of convenience, Y is referred to as direct space, V^{(a)} that is k-orthogonal auxiliary space of Y is referred to as iterative space.
Ku^{(Y)}=F_{(Y)}, u^{(Y)}εY, F_{(Y)}εKY eq 6
Ku^{(a)}=F₍ₐ₎, u^{(a)}εV^{(a)}, F₍ₐ₎εKV^{(a)} eq 7
u=u^{(a)}+u^{(Y)}, F=F₍ₐ₎+F_{(Y)} eq 8
Now consider that a subspace W of the direct space Y is specially determined. This W is referred to as coarse space, herein below. The K-orthogonal auxiliary space of W is referred to as a fine space. When Y is K-orthogonal direct sum decomposed to W and W^{c}, the K-orthogonal auxiliary space of W, equation (9) on W may be set in a manner similar to equation (6) as follows:
u^{(W)}εW:Ku^{(W)}=F_{(W)}, F_{(W)}≡P^{(W)}^{^{T}}FεP^{(W)}^{^{T}}V=KW eq 9
where P^{(W)} designates to the k-orthogonal projector to W. This equation is referred to as the coarse grid problem. If W is defined by setting its base {eⱼ^{(W)}}ⱼ, equation 9 may be formulated to the following equation (10):
u^{(W)}=eⱼ^{(W)}u^{j}, Kᵢⱼ^{(W)}u^{j}=Fᵢ eq 10
Now the following equation (11) is defined:
Kᵢⱼ^{(W)}≡eᵢ^{(W)}·Keⱼ^{(W)}, Fᵢ≡eᵢ^{(W)}·F=eᵢ^{(W)}·F_{(W)} eq 11
where Kᵢⱼ^{(W)} is referred to as a coarse grid matrix. The equal sign in the second equation is due to the orthogonality of W with the image space K(W^{c}β_{K}V^{(a)})) of fine space W^{c}⊕_{K}V^{(a)} by K.

Now consider to solve, among k-orthogonally direct sum decomposed equations, equation (6) by the direct method, and equation (7) by the iteration method. When applying the iteration method to equation (7), iterative equation of n-th step may be written as following equations (12) and (13):
Kuₙ^{(a)}+r₍ₐ₎_{ₙ}=F₍ₐ₎, uₙ^{(a)}εV^{(a)}, F₍ₐ₎εKV^{(a)} eq 12
r₍ₐ₎_{ₙ}≡F₍ₐ₎−Kuₙ^{(a)}, uₙ≡u^{(Y)}+uₙ^{(a)} eq 13
where r₍ₐ₎_{ₙ} designates to the residual error. Note that r₍ₐ₎_{ₙ}εKV^{(a)}. For the iteration method, the CG method with preprocess, which includes P^{(a)}GP^{(a)}^{^{T}} (where G is symmetric) as the preprocess determinant: P^{(a)}GP^{(a)}^{^{T}}−CG method, equations (14) to (16) will be adopted:
p₀=P^{(a)}Gr₍ₐ₎_{₀}εV^{(a)} eq 14

$$\begin{matrix}{u}_{n + 1}^{( a )} = {u}_{n}^{( a )} + {α}_{n} {p}_{n} , {r}_{{( a )}_{n + 1}} = {r}_{{( a )}_{n}} - {α}_{n} {Kp}_{n} , \\ {α}_{n} ≡ \frac{{r}_{{( a )}_{n}} \cdot {Gr}_{{( a )}_{n}}}{{p}_{n} \cdot {kp}_{n}} & eq 15 \\ {p}_{n + 1} = {P}^{( a )} {Gr}_{{( a )}_{n + 1}} + {β}_{n} {p}_{n} , {β}_{n} = \frac{{r}_{{( a )}_{n + 1}} \cdot {Gr}_{{( a )}_{n + 1}}}{{r}_{{( a )}_{n}} \cdot {Gr}_{{( a )}_{n}}} & eq 16\end{matrix}$$

where pₙ designates a search direction vector of P^{(a)}GP^{(a)}^{^{T}}−CG method. Note that P^{(a)}^{^{T}}r₍ₐ₎_{ₙ}=r₍ₐ₎_{ₙ}εKV^{(a)}. As shown here, the method which solves one of equations k-orthogonally direct sum decomposed by the CG method with preprocess is referred to as conjugate projected gradient (CPG) method. In the discussion which follows, such method will be referred to as projected CG method, including solving the other of equations by direct method, for the sake of convenience.

K-orthogonal projector to the subspace W⊕_{K}V^{(a)} is designated to P^{(W+a)}. Although it is impossible to directly compute P^{(a)} itself, P^{(W+a)} may be computable, and now consider a case that the base of W, {eⱼ^{(W)}}ⱼ is given. In such a case the preprocess computation of P^{(a)}Gr₍ₐ₎_{ₙ} in equations (14) and (16) may be conducted as follows: P^{(a)}Gr₍ₐ₎_{ₙ} may be rewritten as equation (17):
P^{(a)}Gr₍ₐ₎_{ₙ}=P^{(W+a)}Gr₍ₐ₎_{ₙ}−μₙ^{(W)}, Kμₙ^{(W)}=P^{(W)}^{^{T}}KGr₍ₐ₎_{ₙ} eq 17
μₙ^{(W)}εW can be determined from equation (4). The preprocessing computation P^{(a)}Gr₍ₐ₎_{ₙ} can be reduced to the coarse grid problem of equation (18).
μₙ^{(W)}εW:Kμₙ^{(W)}=P^{(W)}^{^{T}}KGr₍ₐ₎_{ₙ} eq 18
The coarse grid problem can be solved by following the procedure of equation (10).

To characterizing the CGCG method, conventional finite element method parallel solver algorithm, DDM, BDD method, parallel CG method are now described herein below. As will be described, existent finite element method parallel solver algorithm, DDM, BDD method based on the domain decomposition may be considered to pertain a projected CG method based on the k-orthogonal direct sum decomposition method. In the following, V is defined as space of all degree of freedom in the structure problem determined according to the finite element method, and the linear equation to be solved is given as equation (19) by:
Ku=F, u, FεV eq 19
where K designates to a stiffness matrix.

There is a domain decomposition method (DDM) conceived as a method for efficiently solving (in particular in the parallel processing) a very large scale problem (a problem having the degree of freedom of or more than approximately 1,000,000). Elements decomposed according to the finite element method and adjoining each other are appropriately grouped. The spatial domain occupied by a group is referred to as a subdomain (see FIG. 1). The space is hierarchically decomposed and scattered such that the entire domain is at first decomposed to subdomains, then a subdomain is decomposed to finite elements, and soon. The process on the entire domain will be split into two levels, a process for intra-subdomain and a process for inter-subdomain. The process for intra-subdomain may be paralleled. The two step process as described above may be achieved by separately processing the displacement into the displacement within a subdomain in response to a stress applied to the inside of subdomain, and the remaining displacement in response to a stress applied to the boundary between subdomains (internal boundary). The latter displacement may be further separated into the displacement within the subdomain and the displacement on the internal boundary, the former one is the slave variable of the latter. The degree of freedom of the internal boundary, which is an independent variable, may be solved by the CG method. By solving the internal boundary, the displacement within a subdomain can be determined as the displacement of non-load with the boundary condition of the displacement on the boundary.

More specifically, the entire domain \overline{Ω}occupied by the structure is decomposed to the boundary Γ, domain fused of entire contents of subdomains Ωᵢ, and internal boundary Γₛ. Γ and Γₛ may be partly overlapped. The freedom space of the admissible displacement on the \overline{Ω} constitutes the total space of the degree of freedom V. By using a form function array {φ_{α}}_{α} as the standard orthogonal base, an inner product is defined to V. The inner product may depend on the {φ_{α}}_{α}, and may be set for the convenience of computation which may vary according to the digitizing method, thus may have neither objective nor physical meaning. The domain \overline{Ω}−Γₛ include Ωᵢ. The space Vⁱ of the degree of freedom of the admissible displacement on the \overline{Ω}−Γₛ is perpendicular to the space Vs of the degree of freedom of the admissible displacement on the internal boundary Γₛ, The entire space of the degree of freedom V may be orthogonally direct sum decomposed to Vⁱ and V^{s} as given by equation (20):
V=Vᵢ⊕Vₛ, Vᵢ⊥Vₛ eq 20
Based on this direct sum decomposition, linear transform of positive fixed set point may be block decomposed to

$$K = ( \begin{matrix}{K}_{ii} & {K}_{is} \\ {K}_{si} & {K}_{ss}\end{matrix} ) ,$$

and diagonalized as given by equation (21):

$$K = ( \begin{matrix}{K}_{ii} & {K}_{is} \\ {K}_{si} & {K}_{ss}\end{matrix} ) = ( \begin{matrix}1 & \\ {K}_{si} {K}_{ii}^{- 1} & 1\end{matrix} ) ( \begin{matrix}{K}_{ii} & \\ & S\end{matrix} ) ( \begin{matrix}1 & {K}_{ii}^{- 1} {K}_{is} \\ & 1\end{matrix} ) \qquad eq 21$$

where S is Schur's element. Projectors P⁽ⁱ⁾, P^{(s)} may be defined as equation (22):

$${P}^{( i )} ≡ ( \begin{matrix}1 & {K}_{ii}^{- 1} {K}_{is} \\ & 0\end{matrix} ) , {P}^{( s )} ≡ 1 - {P}^{( i )} = ( \begin{matrix}0 & - {K}_{ii}^{- 1} {K}_{is} \\ & 1\end{matrix} ) \qquad eq 22$$

where P^{(s)} causes the displacement on the internal boundary Γₛ to correspond to the displacement \overline{Ω}−Γₛ that has this boundary condition and receives no stress. From the definition equations (23) and (24) can be derived:

$$\begin{matrix}\begin{matrix}{KP}^{( i )} = ( \begin{matrix}1 & \\ {K}_{si} {K}_{ii}^{- 1} & 1\end{matrix} ) ( \begin{matrix}{K}_{ii} & \\ & 0\end{matrix} ) ( \begin{matrix}1 & {K}_{ii}^{- 1} {K}_{is} \\ & 1\end{matrix} ) \\ = ( \begin{matrix}{K}_{ii} & {K}_{is} \\ {K}_{si} & {K}_{si} {K}_{ii}^{- 1} {K}_{is}\end{matrix} )\end{matrix} & eq 23 \\ {KP}^{( s )} = ( \begin{matrix}0 & \\ & S\end{matrix} ) & eq 24\end{matrix}$$

therefore can be written as equation (25):

$$K ( \begin{matrix}{P}^{( i )} \\ {P}^{( s )}\end{matrix} ) = ( \begin{matrix}{P}^{{( i )}^{T}} \\ {P}^{{( s )}^{T}}\end{matrix} ) K \qquad eq 25$$

where P⁽ⁱ⁾ and P^{(s)} are k-orthogonal projectors, which satisfy the condition P⁽ⁱ⁾+P^{(s)}=1. Note that =P^{(s)}^{^{T}}KP^{(s)}.
Therefore, from these projectors, V may be k-orthogonal direct sum decomposed to equation (26)
V=V⁽ⁱ⁾⊕V^{(s)}, V⁽ⁱ⁾⊥_{K}V^{(s)}, V⁽ⁱ⁾≡P⁽ⁱ⁾V, V^{(s)}≡P^{(s)}V eq 26
The relationship between (Vⁱ V^{s}) and (V⁽ⁱ⁾ V^{(s)}) may be written as equation (27):

$${V}^{( i )} = {V}^{i} , {KV}^{( s )} = ( \begin{matrix}0 \\ {SV}^{s}\end{matrix} ) , \\ {V}^{( s )} = {P}^{( s )} {V}^{s} = ( \begin{matrix}- {K}_{ii}^{- 1} {K}_{is} \\ 1\end{matrix} ) {V}^{s} \qquad eq 27$$

Following can be derived therefrom for V^{(s)}: the second equation indicates that V^{(s)}is a space of displacement where the reaction on \overline{Ω}−Γₛ is zero. On the other hand the third equation indicates that V^{(s)} is a space of displacement on \overline{Ω}, which has as geometric boundary condition the displacement on the Γₛ. Therefore these two characteristics of V^{(s)}are equal. Since the eigenspace belonging to the eigenvalue 0 of the projector P^{(s)}, i.e., kerP^{(s)}, may be kerP^{(s)}=V⁽ⁱ⁾=Vⁱ, then V^{s} and V^{(s)} are linearly uniform. Thus the limitation of P^{(s)} to V^{s}, V^{s}→V^{(s)}, can be found to be linearly uniform. This indicates that when V^{(s)}is a variable space, V^{s} can be instead used for the variable space.

The direct method space Y and iterative method space V^{(a)} of k-orthogonal direct sum decomposed space and equation may be defined as following equation (28):
Y=V⁽ⁱ⁾, V^{(a)}=V^{(s)} eq 28
and the projection CG method (J. Mandel, M. Brezina: Balancing Domain Decomposition: Theory and Performance in two and Three Dimensions, MGNet, http://casper.cs.yale.edu/mgnet/www/mgnet-papers.ht ml) is applied to the preprocessing determinant G of equation (14) to (16) with unit determinant G=1 to yield the Domain Decomposition Method (DDM). V⁽ⁱ⁾ indicates a space of the degree of freedom on the admissible displacement of \overline{Ω}−Γₛ, V^{s} indicates a space of the degree of freedom of the displacement that does not receive any stress on the \overline{Ω}, with the admissible displacement on the Γₛ and the boundary condition thereof (more exactly, displacement restriction condition). KV^{(s)} is a space of the degree of freedom of the reaction force on the internal boundary corresponding to the displacement of V^{(s)}. In the conventional DDM algorithm V^{s} is used for the variable space instead of V^{(s)}, according to the foregoing.

By setting G other than the unit determinant, the DDM with preprocessing can be achieved. For the usual preprocessing determinant G, preprocess is valid when

$$G ≅ {S}^{-} ≡ ( \begin{matrix}0 & \\ & {S}^{- 1}\end{matrix} ) = {P}^{( s )} {K}^{- 1} {P}^{{( s )}^{T}} .$$

Preprocess used in the CG method of the DDM, includes Neumann preprocess (P. Le. Tallec: Domain decomposition methods in computational mechanics, Computational Mechanics Advances 1 (2) (1994) 121-220). This preprocess uses Neumann preprocess determinant as the above preprocess determinant G, instead of unit determinant of 1. Neumann preprocess determinant may be defined as equation (29) below, as representation of block decomposition corresponding to equation (24) by using general inverse determinant S¹⁻ of Schur auxiliary element S¹ (also referred to as local Schur auxiliary element) of the local stiffness matrix K¹ in each subdomain I:

$$G = ( \begin{matrix}0 & \\ & {\sum }_{I} {N}^{I} {D}^{I} {S}^{I -} {D}^{{I}^{T}} {N}^{{I}^{T}}\end{matrix} ) \qquad eq 29$$

where I is the index of subdomain by domain decomposition, N^{I} is 0-1 component determinant, which maps the degree of freedom of subdomain I to the degree of freedom of the entire domain, {D^{I}}_{I} is the set

$$1 = {\sum }_{I} {N}^{I} {D}^{I} {N}^{{I}^{T}}$$

of decomposition determinant of 1 to each subdomain. This preprocess is likely not to satisfy the condition G≅S⁻, depending on the selected general inverse determinant S¹⁻.

By applying Neumann preprocess to the DDM, undetermined rigid displacement for each subdomain may be interfused for each iteration, according to the arbitrary selection of S¹⁻. This may cause random floating movement in subdomains, and may be the cause of aggravation of the efficiency of iterative convergence. This may also be the cause of unsatisfying the condition G≅S⁻. The BDD method (Balancing Domain Decomposition method, J. Mandel: Balancing Domain Decomposition, Communications on Numerical Methods in Engineering 9 (1993) 233-341., J. Mandel, M. Brezina: Balancing Domain Decomposition: Theory and Performance in Two and Three Dimensions, MGNet, http://casper.cs.yale.edu/mgnet/www/mgnet-papers.html, ARASOL An Integrated Programming Environment for Parallel Sparse Matrix Solvers (Project No. 20160), Deliverable D 2.4e Final report Domain Decomposition Algorithms for Large Scale Industrial Finite Element Problems, Jul. 30, 1999) is a solution based on the DDM by using the CG method with preprocessing for the displacement on the internal boundary. Specifically for a static problem of micro deformation of linear material, this method divides the displacement responsive to the stress applied onto the internal boundary to the rigid displacement for each subdomain and residual distortional displacement to solve the former freedom by using the direct method prior to the latter freedom, which will be solved by the CG method with preprocessing. In other words, projection that avoids the interference of the freedom of rigid displacement for each subdomain already solved in advance is added to Neumann preprocessing for every iteration. More specifically, this projection is introduced in such a manner that it eliminates any stress which may cause random floating movement in the subdomain, or it is a correspondence F→F₍ₐ₎ in equations (7) and (8) of k-orthogonally direct sum decomposition, or the projection of residual error r→r₍ₐ₎ in the projected CG method algorithm. As can be seen from the foregoing, the projection as described above is referred to as balancing, which suppresses the floating movement in subdomains by improving the DDM with Neumann preprocessing.

More specifically, subspace V^{(s)}=P^{(s)}V^{s} in the DDM is further k-orthogonally direct sum decomposed as follows: by considering a movement that sum spaces across I of subspace including kerS¹, for example every rigid displacement of a subdomain are summed for all of subdomains, the space of that degree of freedom is defined as a coarse space W. W is a subspace of V^{(s)} V^{(s)} is then k-orthogonally direct sum decomposed to W and k-orthogonal auxiliary space V^{(t)} for V^{(s)}. Now by defining a pair of k-orthogonal projectors P^{(W)} and P^{(t)}, equation (30) can be given:

$${P}^{( s )} = {P}^{( W )} + {P}^{( t )} , K ( \begin{matrix}{P}^{( W )} \\ {P}^{( t )}\end{matrix} ) = ( \begin{matrix}{P}^{{( W )}^{T}} \\ {P}^{{( t )}^{T}}\end{matrix} ) K \qquad eq 30$$

The space of all freedom V may be k-orthogonal direct sum decomposed to equations (31) and (32):
V=V⁽ⁱ⁾⊕W⊕V⁽ⁱ⁾, V⁽ⁱ⁾⊥_{K}W, V⁽ⁱ⁾⊥_{K}V^{(a)}, W⊥_{K}V^{(t)} eq 31
W=P^{(W)}V, V^{(t)}≡P^{(t)}V eq 32

Now define the direct method space and iterative method space of k-orthogonal direct sum decomposition of the space and equation as equation (33):
Y=V⁽ⁱ⁾⊕_{K}W, V^{(a)}=V^{(t)} eq 33

In the BDD method, the projection CG method (J. Mandel, M. Brezina: Balancing Domain Decomposition: Theory and Performance in Two and Three Dimensions, MGNet, http://casper.cs.yale.edu/mgnet/www/mgnet-papers.html) is applied thereto after having preprocessing determinant G of equations (14) to (16) substituted for Neumann preprocessing determinant. In particular, preprocessing corresponding to equations (17) and (18) may be rewritten as equations (34) and (35) as follows, since P^{(W+a)}=P^{(s)}:
P^{(a)}Gr₍ₐ₎_{ₙ}=P^{(s)}Gr₍ₐ₎_{ₙ}−μₙ^{(W)} eq 34
μₙ^{(W)}εW:Kμₙ^{(W)}=P^{(W)}^{^{T}}KGr₍ₐ₎_{ₙ} eq 35

The projection Gr₍ₐ₎_{ₙ}″P^{(s)}Gr₍ₐ₎_{ₙ} may be computed as stated in equation (22).

The iterative space V^{(t)} of the BDD method is also defined together with the later definition of W¹ of the local coarse space. This is also a balanced space. K⁻¹-orthogonal projection from a balanced space to an image space SV^{(a)}, r₍ₐ₎_{ₙ}εSV^{s}→P^{(a)}^{^{T}}r₍ₐ₎_{ₙ}εεSV^{(a)} is referred to as “balancing” (J. Mandel: Balancing Domain Decomposition, Communications on Numerical Methods in Engineering 9 (1993)233-341., J. Mandel, M. Brezina: Balancing Domain Decomposition: Theory and Performance in Two and Three Dimensions, MGNet, http://casper.cs.yale.edu/mgnet/www/mgnet-papers.html). Balancing may not appear directly in algorithm equations (14) to (16) of the projection CG method applied to the BDD method, however is corresponded to k-orthogonal projection Gr₍ₐ₎_{ₙ}εV^{s}⊂V→P^{(a)}Gr₍ₐ₎_{ₙ}εV^{(a)} equations (14) and (16). In contrast to the DDM, even when G of BDD method may be G≢S⁻, if P^{(a)}GP^{(a)}^{^{T}}≅P^{(a)}S⁻P^{(a)}^{^{T}}=P^{(a)}K⁻¹P^{(a)}^{^{T}} then it is valid for the preprocessing. Neumann preprocessing determinant equation (29) satisfies this condition, which may solve the problem of the DDM with Neumann preprocessing, as stated above in the beginning of this section.

In the parallel CG method no domain decomposition is conducted, rather all freedom space V is processed in the CG method. In addition k-orthogonal direct sum decomposition of V is not performed. This corresponds Y={0} for the direct method space. If the problem to be solved is large scaled, and the dimensions of vector space V is large, then the domain subject to be analyzed will be split into some spaces (referred to as “part”) the degree of freedom for every subspaces will be processed in different processors based on the V decomposition (decomposition that leaves boundary overlapped) along with the division. Interprocess communication is necessary only when some computations are conducted, which require information exchange between subspaces such as the inner product of vectors or matrix-vector product.

As can be seen, solutions according to the DDM (Domain Decomposition Method), the DDM with Neumann preprocessing, the BDD (Balancing Domain Decomposition) method, and the parallel CG method have been described, for solving a very large scale structure problem. However, there has been pointed out the problems associated therewith that none of these methods may determine the solution because of divergence at the time of solving a very large scaled structure problem, and the computation is very time-consuming. The present invention has been made in view of the above circumstances and has an object to overcome the above problems and to provide a systematic CGCG method for solving a very large scaled structure problem having the degree of freedom of a million or more, which allows determining the solution without divergence of solutions, with less number of steps of iterative computation, and with less time-consuming computation.

### SUMMARY OF THE INVENTION

The present invention provides a system for solving a very large scaled structure problem, a program for operating the system, and a computer readable recording medium having the program stored thereon. The CGCG method is a finite element method solver algorithm for a very large scaled structure problem, which uses the projection CG method with preprocessing, by performing domain decomposition, defining thereby coarse space without regarding the inside of subdomain and boundary, and adopting simple diagonal scaling for the preprocessing.

The present invention provides a parallel finite element method computing system for solving a very large scaled structure problem having the degree of freedom of one million (1,000,000) or more, characterized by a means for performing domain decomposition; a means for distributing a subdomain to a responsible part of each processor; a means for creating a rigid matrix; a means for defining overlapped movement of entire subdomain; a means for defining a default setting of projected CG method with preprocessing of all degree of freedom; a means for performing iterative computation of projected CG method with preprocessing of all degree of freedom; and a means for outputting a displacement solution.

Said means for defining overlapped movement of entire subdomain may further include a means for creating a projector for displaying all degree of freedom; a means for creating an overlapped movement matrix of entire subdomain; and a means for LU decomposing said overlapped movement matrix of entire subdomain.

Said means for defining a default setting of projected CG method with preprocessing of all degree of freedom may further include a means for setting initial displacement of all degree of freedom; a means for performing computation of initial residual error of all degree of freedom; a means for performing computation of diagonal scaling preprocessing; a means for performing computation of coarse grid preprocessing of all degree of freedom; and a means for defining an initial vector value in the search direction of CG method with all degree of freedom.

Said means for performing iterative computation of projected CG method with preprocessing of all degree of freedom may further include a means for updating the displacement of all degree of freedom; a means for updating the residual error of all degree of freedom; a means for performing computation of diagonal scaling preprocessing; a means for performing computation of coarse grid preprocessing of all degree of freedom; a means for updating vectors in the search direction of CG method of all degree of freedom; and a means of determining the convergence.

The present invention may also provide a program for operating said system. More specifically, the present invention provides a parallel finite element method computing program used in a parallel finite element method computing system for solving a very large scaled structure problem having the degree of freedom of one million (1,000,000) or more, characterized by operating as a means for performing domain decomposition; a means for distributing a subdomain to a responsible part of each processor; a means for creating a rigid matrix; a means for defining overlapped movement of entire subdomain; a means for defining a default setting of projected CG method with preprocessing of all degree of freedom; a means for performing iterative computation of projected CG method with preprocessing of all degree of freedom; and a means for outputting a displacement solution,
in which said means for defining overlapped movement of entire subdomain may further operate as a means for creating a projector for displaying all degree of freedom; a means for creating an overlapped movement matrix of entire subdomain; and a means for LU decomposing said overlapped movement matrix of entire subdomain;
in which said means for defining a default setting of projected CG method with preprocessing of all degree of freedom may further operate as a means for setting initial displacement of all degree of freedom; a means for performing computation of initial residual error of all degree of freedom; a means for performing computation of diagonal scaling preprocessing; a means for performing computation of coarse grid preprocessing of all degree of freedom; and a means for defining an initial vector value in the search direction of CG method with all degree of freedom;
in which said means for performing iterative computation of projected CG method with preprocessing of all degree of freedom may further operate as a means for updating the displacement of all degree of freedom; a means for updating the residual error of all degree of freedom; a means for performing computation of diagonal scaling preprocessing; a means for performing computation of coarse grid preprocessing of all degree of freedom; a means for updating vectors in the search direction of CG method of all degree of freedom; and a means of determining the convergence.

The present invention provides a computer readable recording medium having the program stored thereon for operating said system. More specifically, the present invention provides a computer readable recording medium having stored thereon a parallel finite element method computing program used in a parallel finite element method computing system for solving a very large scaled structure problem having the degree of freedom of one million (1,000,000) or more, characterized by operating as a means for performing domain decomposition; a means for distributing a subdomain to a responsible part of each processor; a means for creating a rigid matrix; a means for defining overlapped movement of entire subdomain; a means for defining a default setting of projected CG method with preprocessing of all degree of freedom; a means for performing iterative computation of projected CG method with preprocessing of all degree of freedom; and a means for outputting a displacement solution,
in which said means for defining overlapped movement of entire subdomain may further operate as a means for creating a projector for displaying all degree of freedom; a means for creating an overlapped movement matrix of entire subdomain; and a means for LU decomposing said overlapped movement matrix of entire subdomain;
in which said means for defining a default setting of projected CG method with preprocessing of all degree of freedom may further operate as a means for setting initial displacement of all degree of freedom; a means for performing computation of initial residual error of all degree of freedom; a means for performing computation of diagonal scaling preprocessing; a means for performing computation of coarse grid preprocessing of all degree of freedom; and a means for defining an initial vector value in the search direction of CG method with all degree of freedom;
in which said means for performing iterative computation of projected CG method with preprocessing of all degree of freedom may further operate as a means for updating the displacement of all degree of freedom; a means for updating the residual error of all degree of freedom; a means for performing computation of diagonal scaling preprocessing; a means for performing computation of coarse grid preprocessing of all degree of freedom; a means for updating vectors in the search direction of CG method of all degree of freedom; and a means of determining the convergence.

The above and further objects and novel features of the present invention will more fully appear from following detailed description of a preferred embodiment, when the same is read in connection with the accompanying drawings. It is to be expressly understood, however, tha the drawings are for the purpose of illustration only and not intended as a definition of the limits of the present invention.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a schematic diagram illustrating domain decomposition; and

FIG. 2 is a schematic flowchart illustrating computation in the CGCG method.

### DETAILED DESCRIPTION

The CGCG method is a finite element method solver algorithm used for a very large scaled structure problem, using a projected CG method with preprocessing, by performing domain decomposition, defining a coarse space without distinguishing inside of subdomain with boundary, and adopting simple diagonal scaling for the preprocess. Similar to the DDM and the BDD method, the CGCG method is formed on the projected CG method, which is based on the domain decomposition. First, define Y=W, and according to equation (3), all freedom space V is k-orthogonally direct sum decomposed as following equation (36):

$$V = W ⊕ {V}^{( a )} , W {⊥}_{K} {V}^{( a )} , ( \begin{matrix}W \\ {V}^{( a )}\end{matrix} ) = ( \begin{matrix}{P}^{( W )} \\ {P}^{( a )}\end{matrix} ) V \qquad eq 36$$

here lies a problem to select which subspace of V as the coarse space W. In the CGCG method, a subspace of V is to be elected which represents for W some limited movement (such as rigid motion) for each subdomain in the domain decomposition.

For example, in a manner similar to the BDD method, if a space having the degree of freedom of movement overlapping for every subdomains rigid displacement of each of subdomains is selected for W, then V^{(a)} constitutes the space of displacement indicative of distortion motion within the subdomain. Thus in comparison with equation (33) of the BDD method the direct method space and repetitive method space may be formed as shown in equation (37):
Y=W, V^{(a)}=V⁽ⁱ⁾⊕V^{(t)}, V⁽ⁱ⁾⊥_{K}V^{(t)} eq 37

In this case, while the BDD method solves by direct method the degree of freedom of V⁽ⁱ⁾, the CGCG method attempts to solve it by using the CG method. In this situation the CGCG method imposes much more burden on the CG method and less on direct method. Also in the projected CG method preprocessing of the CGCG method, the direct method has less roles due to the lack of projection processing Gr₍ₐ₎_{ₙ}→P^{(s)}Gr₍ₐ₎_{ₙ} of equation (34) of the BDD method.

The management of the implementation of coarse space W may also differ, reflecting the difference between the DDM method and the parallel CG method. In the DDM, as V^{s} is used for the variable space, the displacement of entire domain is divided into the displacement inside the subdomain and that on the internal boundary. In the parallel CG method subdomain is not divided into its inside and internal boundary but the inside and internal boundary of subdomains are handled as whole. Coarse space W in the BDD method may be defined as follows: The rigid displacement in the boundary of each subdomain (part of internal boundary) is at first formulated, then the space Ws overlapping over the entire subdomain is set. Then the result will be k-orthogonally projected by P^{(s)} of equation (22) to expand to rigid displacement in the subdomain to yield W (i.e., W=P^{(s)}W^{s}). On the other hand coarse space W in the CGCG method is set by directly formulating the rigid displacement of both inside and boundary entirely for each subdomain to overlap across that subdomain. Accordingly the preprocessing of the projected CG method involves much effort in solving the degree of freedom of space Ws as well as in direct method processing for each and every subdomain (due to the computation of Schur auxiliary element). In contrast to the BDD method, the CGCG method may need only to solve the degree of freedom of rigid displacement for each subdomain including its inside.

Now equation (1) is decomposed to equations (38) (39), (40) in a manner similar to equations (6) to (8):
Ku^{(W)}=F_{(W)}, u^{(W)}εW, F_{(W)}εKW eq 38
Ku^{(a)}=F₍ₐ₎, u^{(a)}εV^{(a)}, F₍ₐ₎εKV^{(a)} eq 39
u=u^{(a)}+u^{(W)}, F=F₍ₐ₎+F_{(W)} eq 40

Equation (38) represents the coarse grid problem for determining W component of displacement u^{(W)}, equation (39) represents the equation for determining V^{(a)} component of displacement u^{(a)}. The CG method solves equation (38) using modified Choleski method, which is one of direct methods, and equation (39) using the CG iterative processing with preprocessing of the projected CG method, in a manner similar to the projected CG method. The preprocessing determinant \overline{G} of the CG iterative method with preprocessing is selected, in accordance with equations (14) to (16), to be G=D_{K}⁻¹ to define equation (41):
\overline{G}=P^{(a)}D_{K}⁻¹P^{(a)}^{^{T}} eq 41
where D_{K}⁻¹ designates to an inverse matrix of D_{K}, D_{K} to a diagonal matrix of K (a diagonal matrix having diagonal components equal to those of K). The effect on residual error r₍ₐ₎_{ₙ}εKV^{(a)} may be substantially \overline{G}r₍ₐ₎_{ₙ}=P^{(a)}D_{K}⁻¹r₍ₐ₎_{ₙ}, i.e. the preprocessing in the CGCG method is the combination of diagonal scaling of K with k-orthogonal projection P^{(a)} to the iterative space V^{(a)}.

In the BDD method Neumann preprocessing is performed, which is a heavy processing for computing general inverse matrix S¹⁻ of local Schur auxiliary element S¹ for every subdomain, while on the other hand the CGCG method reduces the burden by using much simpler and lightweight preprocessing, namely diagonal scaling, to significantly decrease the computational cost and required amount of memory.

The definition of coarse space W in k-orthogonal decomposition equation (36) by the CGCG method will be now described below. I designates to the index of subdomains by the domain decomposition. The vector space made by the degree of freedom within the subdomain I is represented by V^{I}. The subspace W^{I} of V^{I} is then defined, which is referred to as “local coarse space”. Weighted overlap of {W^{I}}_{I} of coarse space W defines as equation (42):
W≡span{N^{I}D^{I}W^{I}}_{I}}=⊕N^{I}D^{I}W^{I} eq 42
S where {D^{I}}_{I} indicates the decomposition of I to subdomains in a manner similar to Neumann preprocessing,

$$1 = {\sum }_{I} {N}^{I} {D}^{I} {N}^{{I}^{T}} .$$

W^{I} is the space of displacement indicative of defined movement (for example rigid motion) of subdomain I. m^{I}≡dim W^{I} is defined as the dimension of W^{I}, {Zⱼ^{I}}_{j=1,L,m}_{^{I}} and as the base of W^{I}.
{N^{I}D^{I}Zⱼ^{I}}_{j=1,L,m}^{t}_{I} eq 43

Equation (43) constitutes the base of W, and the dimension of

$$W is {\sum }_{I} {m}^{I} .$$

If W^{I} satisfies the condition kerS^{I} ⊂W^{I} in particular, the subspace of corresponding fine space is referred to as balanced space. In the BDD method, which performs Neumann preprocessing, W^{I} needs to satisfy the condition kerS^{I} ⊂W^{I}, while the CGCG may not. In other words, The iterative space V^{(a)} of the CGCG method does not need to be a balanced space.

Now consider a rigid motion, as a defined movement in the subdomain I. At this time W^{I} may be practically formed as follows. The rigid motion in the subdomain I can be represented as described below. By defining X_{α}^{I} as the initial coordinate of node α on the subdomain I, X_{α}^{I} as the coordinate after the deformation, following equations (44), (45), (46) can be given:
x_{α}^{I}=Pⱼv^{j}+e^{I}^{θ}^{^{j}}X_{α}^{I} eq 44

$$\begin{matrix}{P}_{1} ≡ ( \begin{matrix}\begin{matrix}1 \\ 0\end{matrix} \\ 0\end{matrix} ) , {P}_{2} ≡ ( \begin{matrix}\begin{matrix}0 \\ 1\end{matrix} \\ 0\end{matrix} ) , {P}_{3} ≡ ( \begin{matrix}\begin{matrix}0 \\ 0\end{matrix} \\ 1\end{matrix} ) & eq 45 \\ {O}_{1} ≡ ( \begin{matrix}0 & & \\ & & - 1 \\ & 1 & \end{matrix} ) , {O}_{2} ≡ ( \begin{matrix} & & 1 \\ & 0 & \\ - 1 & & \end{matrix} ) , {O}_{3} ≡ ( \begin{matrix} & - 1 & \\ 1 & & \\ & & 0\end{matrix} ) & eq 46\end{matrix}$$

When considering micro-deformation, following equations (47) and (48) can be derived:
x_{α}^{I}≅Pⱼv^{j}+(1+Oⱼθ^{j})X_{α}^{I} eq 47

$${u}_{α}^{I} ≅ {P}_{j} {v}^{j} + {O}_{j} {X}_{α}^{I} {θ}^{j} = v + θ \times {X}_{α}^{I} , v ≡ ( \begin{matrix}\begin{matrix}{v}^{1} \\ {v}^{2}\end{matrix} \\ {v}^{3}\end{matrix} ) , θ ≡ ( \begin{matrix}\begin{matrix}{θ}^{1} \\ {θ}^{2}\end{matrix} \\ {θ}^{3}\end{matrix} ) \qquad eq 48$$

Now define W^{I} by 6 dimension vector space having the base of six displacement {Zⱼ^{I}}_{j=1,L,6} on the subdomain I defined by the following condition. This means following equations (49) and (50):

$$\begin{matrix}\begin{matrix}{Z}_{j}^{I} : {Z}_{J}^{I} ( {X}_{α}^{I} ) = {P}_{j} \\ {Z}_{3 + j}^{I} : {Z}_{3 + j}^{I} ( {X}_{α}^{I} ) = {O}_{j} {X}_{α}^{I}\end{matrix} , j = 1 , 2 , 3 & eq 49 \\ {W}^{I} ≡ \{ {\sum }_{j = 1}^{{m}^{I}} {Z}_{j}^{I} {μ}^{j} \vert {μ}^{j} ∈ R \} , {m}^{I} \leq 6 & eq 50\end{matrix}$$

Note that in equation 50 following condition is taken into account. Depending on subdomains, the degree of freedom of rigid motion may be less than or equal to 5. In such a situation the number j of term Zⱼ^{I} should be renumbered such that the base becomes {Zⱼ^{I}}_{j=1,L,m}_{^{I}}, m^{I}≡-dim W^{I}≦6. Renumbering of the number j uses Gram-Schmidt orthogonal method.

The BDD method is different from the CGCG method in that it defines six displacements on the internal boundary for the {Zⱼ^{I}}_{j=1,L,6} defined by equation (49), instead of those on subdomain I.

It may be easy to apply the formulae of rigid motion as defined movement as above to the rigid motion of the solid model of the micro deformation problem. In case of the solid model, those six displacements {Zⱼ^{I}}_{j=1,L,6} on the subdomain I defined by equation (49) will have its node component α as equation (51) below:

$$\{ {Z}_{1}^{I} ( {X}_{α}^{I} ) , {Z}_{2}^{I} ( {X}_{α}^{I} ) , {Z}_{3}^{I} ( {X}_{α}^{I} ) , {Z}_{4}^{I} ( {X}_{α}^{I} ) , {Z}_{5}^{I} ( {X}_{α}^{I} ) , {Z}_{6}^{I} ( {X}_{α}^{I} ) \} = ( \begin{matrix}1 & 0 & 0 & 0 & {X}^{{α}^{3}} & - {X}^{{α}^{2}} \\ 0 & 1 & 0 & - {X}^{{α}^{3}} & 0 & {X}^{{α}^{1}} \\ 0 & 0 & 1 & {X}^{{α}^{2}} & - {X}^{{α}^{1}} & 0\end{matrix} ) \qquad eq 51$$

where X_{α}^{I} is the initial coordinate of the node α on the subdomain I.

Next, the application to the micro deformation problem shell model will be described. Now one of standard orthogonal bases at the contact space of the shell neutral plane at the node α is selected to be (e₁^{α} e₂^{α}). e₃^{α} is defined as the initial director of the node α. A coordinate x=x(ξ¹, ξ², ξ³) of the point on a shell element can be written as equation (52):

$$x = {\sum }_{α}^{} {N}_{α} ( {ξ}^{1} , {ξ}^{2} ) ( {X}^{α} + {U}^{α} + \frac{{a}^{α} {ξ}^{3}}{2} ( 1 + {φ}^{α} \times ) {e}_{3}^{α} ) \qquad eq 52$$

where (ξ¹, ξ², ξ³) is the local coordinate of that shell element. Also, N_{α}, X^{α}, U^{α}, φ^{α} are shape functions of node a, defined on the shell neutral plane, initial node coordinate, current node displacement, amount of rotation of the current director, respectively.

$${\sum }_{α}$$

indicates the sum over nodes included in the shell element in question.

The micro-translation of shell x→x+a may be rewritten as equation (53):

$$x -> x + a = {\sum }_{α}^{} {N}_{α} [ {X}^{α} + {U}^{α} + a + \frac{{a}^{α} {ξ}^{3}}{2} ( 1 + {φ}^{α} \times ) {e}_{3}^{α} ] \qquad eq 53$$

in other words, when focusing on the change of the node displacement U^{α} and the amount or rotation of the current director φ^{α}, following equation (54) can be yielded:

$$x -> x + a = {\sum }_{α}^{} {N}_{α} [ {X}^{α} + {U}^{α} + a + \frac{{a}^{α} {ξ}^{3}}{2} ( 1 + {φ}^{α} \times ) {e}_{3}^{α} ] \qquad eq 53$$

Now consider the rigid micro-rotation of the shell. The displacement U^{α} and the rotation of current director φ^{α} may be assumed microscopic. Now a rigid micro-rotation 1+Oᵢθⁱ=1+θx is effectuated to the coordinate x=x(ξ¹, ξ², ξ³). Now {Oᵢ}_{i=1,2,3} is the matrix defined by equation 46, and θ=(θ¹ θ² θ³)^{T} is the vector in the rotating direction. The current node coordinate X^{α}+U^{α} by the rigid micro-rotation, the amount of change of the current director ψ^{α}≅(1+φ^{α}x)e₃^{α} may be expressed as equation (55) when considering to microscopic amount first order:
θ×(X^{α}+U^{α})≅θ×X^{α}, θ×(1+φ^{α}×)e₃^{α}≅θ×e₃^{α}=θ^{α}×e₃^{α} eq 55
Now θ^{α} can be written as a vector equation (56), which projects θ to the contact space of the shell neutral plane at the node α (subspace extending over (e₁^{α} e₂^{α})):

$${θ}^{α} ≡ ( {e}_{1}^{α} {e}_{2}^{α} ) ( \begin{matrix}{e}_{1}^{α} \cdot θ \\ {e}_{2}^{α} \cdot θ\end{matrix} ) \qquad eq 56$$

Thus the amount of change of entire coordinate x due to the rigid micro-rotation can be written by equation (57):

$$θ \times x ≅ {\sum }_{α}^{} {N}_{α} ( θ \times {X}^{α} + \frac{{a}^{α} {ξ}^{3}}{2} {θ}^{α} \times {e}_{3}^{α} ) \qquad eq 57$$

Therefore the rigid micro-rotation of the shell can be rewritten as equation 58 as follows, when focusing on the node displacement U^{α} and the amount of rotation of the current director φ^{α}:

$$( \begin{matrix}{U}^{α} \\ {φ}^{α}\end{matrix} ) -> ( \begin{matrix}{U}^{α} + θ \times {X}^{α} \\ {φ}^{α} + {θ}^{α}\end{matrix} ) \qquad eq 58$$

When combining the micro-translation x→x+a and rigid micro-rotation x→(1+θ×)x, next equation can be yielded:

$$( \begin{matrix}{U}^{α} \\ {φ}^{α}\end{matrix} ) -> ( \begin{matrix}{U}^{α} + a + θ \times {X}^{α} \\ {φ}^{α} + {θ}^{α}\end{matrix} ) \qquad eq 59$$

If the additional term

$$( \begin{matrix}a + θ \times {X}^{α} \\ {θ}^{α}\end{matrix} )$$

is written as component, equation (60) can be written:

$$( \begin{matrix}a + θ \times {X}^{α} \\ {θ}^{α}\end{matrix} ) = ( \begin{matrix}1 & 0 & 0 & 0 & {X}^{{α}^{3}} & - {X}^{{α}^{2}} \\ 0 & 1 & 0 & - {X}^{{α}^{3}} & 0 & {X}^{{α}^{1}} \\ 0 & 0 & 1 & {X}^{{α}^{2}} & - {X}^{{α}^{1}} & 0 \\ 0 & 0 & 0 & {e}_{1}^{{α}^{1}} & {e}_{1}^{{α}^{2}} & {e}_{1}^{{α}^{3}} \\ 0 & 0 & 0 & {e}_{2}^{{α}^{1}} & {e}_{2}^{{α}^{2}} & {e}_{2}^{{α}^{3}}\end{matrix} ) ( \begin{matrix}{a}^{1} \\ {a}^{2} \\ {a}^{3} \\ {θ}^{1} \\ {θ}^{2} \\ {θ}^{3}\end{matrix} ) \qquad eq 60$$

It indicates that the component of the node α in the six displacement {Zⱼ^{I}}_{j=1,L,6} on the subdomain I defined by equation (49) may be expressed as following equation (61):

$$\begin{matrix}\{ {Z}_{1}^{I} ( {X}_{α}^{I} ) , {Z}_{2}^{I} ( {X}_{α}^{I} ) , {Z}_{3}^{I} ( {X}_{α}^{I} ) , {Z}_{4}^{I} ( {X}_{α}^{I} ) , {Z}_{5}^{I} ( {X}_{α}^{I} ) , {Z}_{6}^{I} ( {X}_{α}^{I} ) \} = \\ ( \begin{matrix}1 & 0 & 0 & 0 & {X}^{{α}^{3}} & - {X}^{{α}^{2}} \\ 0 & 1 & 0 & - {X}^{{α}^{3}} & 0 & {X}^{{α}^{1}} \\ 0 & 0 & 1 & {X}^{{α}^{2}} & - {X}^{{α}^{1}} & 0 \\ 0 & 0 & 0 & {e}_{1}^{{α}^{1}} & {e}_{1}^{{α}^{2}} & {e}_{1}^{{α}^{3}} \\ 0 & 0 & 0 & {e}_{2}^{{α}^{1}} & {e}_{2}^{{α}^{2}} & {e}_{2}^{{α}^{3}}\end{matrix} )\end{matrix} \qquad eq 61$$

where X_{α}^{I} is the initial coordinate of the node α on the subdomain I.

Now consider a movement represented by the affine transformation (a transformation characterized by mirroring a segment to another segment without any change of directed line segment ratio) for the defined movement of the subdomain I (referred to as affine transformation movement herein below).

This is the generalization of rigid motion discussed in the foregoing section, which is the combination of the translational motion and generalized linear transformation motion. W^{I} can be constructed in a practical sense as follows:

The affine transformation movement of the subdomain I can be expressed as follows. Define X_{α}^{I} as the initial coordinate of the node a on the subdomain I, x_{α}^{I} as the coordinate after transformation,
x_{α}^{I}=Pⱼv^{j}+e^{E}^{ⱼ}^{^{e}}^{α}^{^{j}}^{+E}^{ⱼ}^{^{s}}^{ε}^{^{j}}^{+O}^{ⱼ}^{θ}^{^{j}}X_{α}^{I} eq 62

$$\begin{matrix}\begin{matrix}{E}_{1}^{e} ≡ ( \begin{matrix}1 & & \\ & 0 & \\ & & 0\end{matrix} ) , & {E}_{2}^{e} ≡ ( \begin{matrix}0 & & \\ & 1 & \\ & & 0\end{matrix} ) , & {E}_{3}^{e} ≡ ( \begin{matrix}0 & & \\ & 0 & \\ & & 1\end{matrix} )\end{matrix} & eq 63 \\ \begin{matrix}{E}_{1}^{s} ≡ ( \begin{matrix}0 & & \\ & & 1 \\ & 1 & \end{matrix} ) , & {E}_{2}^{s} ≡ ( \begin{matrix} & & 1 \\ & 0 & \\ 1 & & \end{matrix} ) , & {E}_{3}^{s} ≡ ( \begin{matrix} & 1 & \\ 1 & & \\ & & 0\end{matrix} )\end{matrix} & eq 64\end{matrix}$$

Or equations (65), (66), (67), and (68) below:
x_{α}^{I}=Pⱼv^{j}+^{E}^{ᵢⱼ}^{θ}^{^{X}}_{α}^{I} eq 65

$$\begin{matrix}\begin{matrix}{E}_{11} ≡ ( \begin{matrix}1 & & \\ & 0 & \\ & & 0\end{matrix} ) , & {E}_{12} ≡ ( \begin{matrix}0 & 1 & \\ & 0 & \\ & & 0\end{matrix} ) , & {E}_{13} ≡ ( \begin{matrix}0 & & 1 \\ & 0 & \\ & & 0\end{matrix} )\end{matrix} & eq 66 \\ \begin{matrix}{E}_{21} ≡ ( \begin{matrix}0 & & \\ 1 & 0 & \\ & & 0\end{matrix} ) , & {E}_{22} ≡ ( \begin{matrix}0 & & \\ & 1 & \\ & & 0\end{matrix} ) , & {E}_{23} ≡ ( \begin{matrix}0 & & \\ & 0 & 1 \\ & & 0\end{matrix} )\end{matrix} & eq 67 \\ \begin{matrix}{E}_{31} ≡ ( \begin{matrix}0 & & \\ & 0 & \\ 1 & & 0\end{matrix} ) , & {E}_{32} ≡ ( \begin{matrix}0 & & \\ & 0 & \\ & 1 & 0\end{matrix} ) , & {E}_{33} ≡ ( \begin{matrix}0 & & \\ & 0 & \\ & & 1\end{matrix} )\end{matrix} & eq 68\end{matrix}$$

Equations (69) and (70) when considering the micro-deformation.
x_{α}^{I}≅Pⱼv^{j}+(1+Eᵢⱼθ^{ij})X_{α}^{I} eq 69

$$\begin{matrix}{u}_{α}^{I} ≅ {P}_{j} {v}^{j} + {E}_{ij} {X}_{α}^{I} {θ}^{ij} , & v ≡ ( \begin{matrix}{v}^{1} \\ {v}^{2} \\ {v}^{3}\end{matrix} ) , & {θ}^{ij} ≡ ( \begin{matrix}{θ}^{11} & {θ}^{12} & {θ}^{13} \\ {θ}^{21} & {θ}^{22} & {θ}^{23} \\ {θ}^{31} & {θ}^{32} & {θ}^{33}\end{matrix} )\end{matrix} \qquad eq 70$$

Now define W^{I} in 12 dimension vector space having its base of twelve displacements {Zⱼ^{I}}_{j=1,L,12} on the subdomain I defined by the following condition given by:

$$( \begin{matrix}{U}^{α} \\ {φ}^{α}\end{matrix} ) -> ( \begin{matrix}{U}^{α} + a \\ {φ}^{α}\end{matrix} ) \qquad eq 54$$

then,

$$\begin{matrix}{W}^{I} ≡ \{ {\sum }_{j = 1}^{{m}^{I}} {Z}_{j}^{I} {μ}^{j} \vert {μ}^{j} ∈ R \} , & & {m}^{I} \leq 12\end{matrix} \qquad eq 72$$

Equation 72 considers the following situation as similar to the case of rigid motion. Depending on subdomains, the degree of freedom of the affine transformation movement can be equal to or less than 11. In such a situation the number j of Zⱼ^{I} should be renumbered such that the base becomes {Zⱼ^{I}}_{j=1,L,m}^{_{I}}, m^{I}≡dim W^{I}≦12. Gram-Schmidt orthogonal method is used for renumbering of the number j

Now the computation procedure in practice of the parallel finite element method solver according to the CGCG method will be described in greater details below.

1. Domain Decomposition

The domain subject to be analyzed is decomposed to a plurality of subdomains.

2. Distribution of Subdomains to Responsible Part of Processors

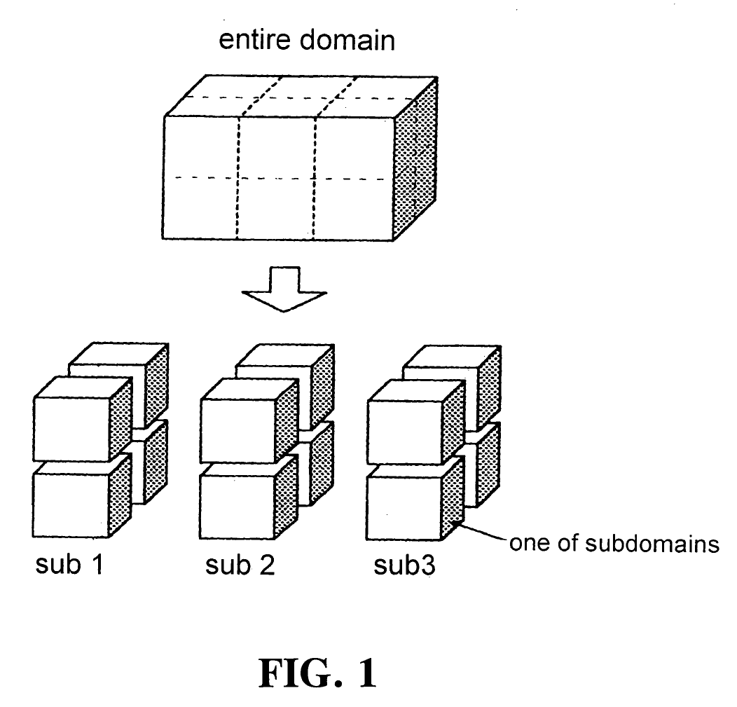

The allocation of decomposed subdomains to each computing node (CPU) is determined. More specifically, each computing node (CPU) is responsible for one of or a plurality of subdomains. The entire subdomains processed by a node is referred to as a “part” (see FIG. 1).

3. Creation of Rigid Matrix

A rigid matrix corresponding to the subdomain processed by a CPU is created.

4. Setting of Overlapped Motion of Entire Subdomain

4.1. Creation of Projector Displaying All Degree of Freedom

The base (the base of subspace can be considered as a projector to that subspace) of coarse space displaying all degree of freedom, D^{I}Z^{I}={D^{I}Zⱼ^{I}}_{j=1,L,m}^{_{I}} is created for each subdomain processed by a node, for extracting the overlapped motion of all subdomains.

4.2. Creation of the Matrix K_{rgd} of Overlapped Motion of All Subdomains

the matrix of overlapped motion of all subdomains K_{rrg}=K_{rgd}_{ᵢⱼ}^{I}^{^{J}}=D^{I}Zᵢ^{I}·KD^{J}Zⱼ^{J} is formed. This computation can be conducted by determining the contribution from that subdomain at the node that maintains the rigid matrix K^{I} of subdomains, and summing all the contributions.

4.3. LU Decomposition of the Matrix K_{rgd} of Overlapped Motion of All Subdomains

LU decomposition K_{rgd}=L_{rgd}U_{rgd} is executed on K_{rgd}. The L_{rgd}, U_{rgd} thus LU decomposed are kept in all of nodes.

5. Initial Setting of Projected CG Method with Preprocessing of All Degree of Freedom

5.1. Initial Displacement Setting of All Degree of Freedom

5.1.1. Overlapped Movement of All Subdomains μ^{(W)}

Solve the following equation (73) for μ^{(W)}:
K_{rgd}μ^{(W)}=(NDZ)^{T}F eq 73
where NDZ≡{N^{I}D^{I}Zⱼ^{I}}_{j=1,L,m}_{^{I}}_{_{I}}. F is kept by the node with respect to the responsible part, and the nodes will communicate each other after solving (NDZ)^{T}F to create the right side vector of entire domain, and uses K_{rgd} that has LU decomposed by all nodes to determine μ^{(W)}. The term corresponding to u^{(W)} of equation (10) will be u^{(W)}=NDZμ^{(W)}.
5.1.2. Setting of Initial Displacement u₀

Initial displacement u₀ is set according to equation (74) below:
u₀=NDZμ^{(W)} eq 74

u₀ is kept by each node for their responsible part.

5.2. Computation of Initial Residual Error g₀ of All Degree of Freedom

Initial residual error g₀ will be determined according to equation (75) below:
g₀=Ku₀−F eq 75
This residual vector is held by each node for their responsible part. Note here that the sign is inverted with respect to the residual error r₍ₐ₎_{ₙ} discussed by referring to equations (14) to (16).
5.3. Computation of Diagonal Scaling Preprocessing

Determine D_{K}⁻¹g₀ go for the residual error g₀ (this is the diagonal scaling preprocessing). D_{K}⁻¹ is the inverse matrix of D_{K}, D_{K} is the diagonal matrix of K (diagonal matrix which has diagonal components equal to the diagonal components of K). Each node solves this for their responsible part.

5.4. Computation of Coarse Grid Preprocessing of All Degree of Freedom

Coarse grid preprocessing P^{(a)}Gg₀=\overline{G}g₀ is executed as follows:

5.4.1. Overlapped Motion Variable for All Subdomains μ^{(W)}

Solve the following equation (76) for μ^{(W)}:
K_{rdg}μ^{(W)}=−(NDZ)^{T}KD_{K}⁻¹g₀ eq 76
where right side vector is created by all nodes communicating each other for the entire domain, and all nodes solve μ^{(W)}.
5.4.2. Setting μ₀^{(W)}

setting μ₀^{(W)} according to equation (77)
μ₀^{(W)}=NDZμ^{(W)} eq 77
μ₀^{(W)} is held for the responsible part.
5.4.3. Computation of P^{(a)}Gg₀=\overline{G}g₀

\overline{G}g₀ is computed according to equation (78) below:
\overline{G}g₀=μ₀^{(W)}+D_{K}⁻¹g₀

This can be solved for the responsible part.

5.5. Setting of Initial Vector Value w₀ in the Search Direction of the CG Method of All Degree of Freedom

Initial vector value w₀ in the search direction of the CG method of all degree of freedom will be set according to equation (79) below:
w₀=\overline{G}g₀ eq 79

This can be solved for the responsible part.

6. Iterative Computation by the Projected CG Method with Preprocessing of All Degree of Freedom

6.1. Displacement Update of All Degree of Freedom

For n≧1, displacement of all degree of freedom uₙ₋₁ is updated according to the following procedure.

6.1.1. Computation of Kwₙ₋₁

Kwₙ₋₁ is determined for the responsible part.

6.1.2. Computation of αₙ

All nodes communicating each other will determine αₙ according to equation (80).

$${α}_{n} = \frac{{g}_{n - 1} \cdot \overline{G} {g}_{n - 1}}{{w}_{n - 1} \cdot K {w}_{n - 1}} \qquad eq 80$$

6.1.3. Update of the Responsible Part of uₙ₋₁

The responsible part of uₙ₋₁ will be updated according to equation (81).
uₙ=uₙ₋₁−αₙwₙ₋₁ eq 81
6.2. Update of Residual Error of All Degree of Freedom

For n≧1, the responsible part of residual error gₙ₋₁ of all degree of freedom will be updated according to equation 82.
gₙ=gₙ₋₁−αₙKwₙ₋₁ eq 82
6.3. Computation of Diagonal Scaling Preprocessing D_{K}⁻¹gₙ

Similar to 5.3., each node will solve D_{K}⁻¹gₙ for the residual error gₙ for their respective responsible part (diagonal scaling preprocessing).

6.4. Computation of Coarse Grid Preprocessing \overline{G}gₙ of All Degree of Freedom

Using the same procedure as 5.4., \overline{G}gₙ will be determined for the responsible part. More specifically, two equations (83) and (84) will be solved to form equation (85).
K_{rgd}μ^{(W)}=−(NDZ)^{T}KD_{K}⁻¹gₙ eq 83
μₙ^{(W)}=NDZμ^{(W)} eq 84
\overline{G}gₙ−μₙ^{(W)}+D_{K}⁻¹gₙ eq 85
6.5. Update of Vector wₙ₋₁ of Search Direction of the CG Method of All Degree of Freedom

wₙ₋₁ will be update according to the following procedure.

6.5.1. Computation of βₙ

βₙ will be determined by all nodes communicating each other according to equation (86).

$${β}_{n} = \frac{{g}_{n} \cdot \overline{G} {g}_{n}}{{g}_{n - 1} \cdot \overline{G} {g}_{n - 1}} \qquad eq 86$$

6.5.2. Update of wₙ₋₁

wₙ₋₁ will be updated for the responsible part according to equation (87):
wₙ=\overline{G}gₙ+βₙwₙ₋₁ eq 87
6.6. Determining Convergence

The convergence will be determined from the updated residual error gₙ. If not convergent, then the procedure will go back to step 6.1. to repeat the steps that follow.

7. Output of Displacement Solution u

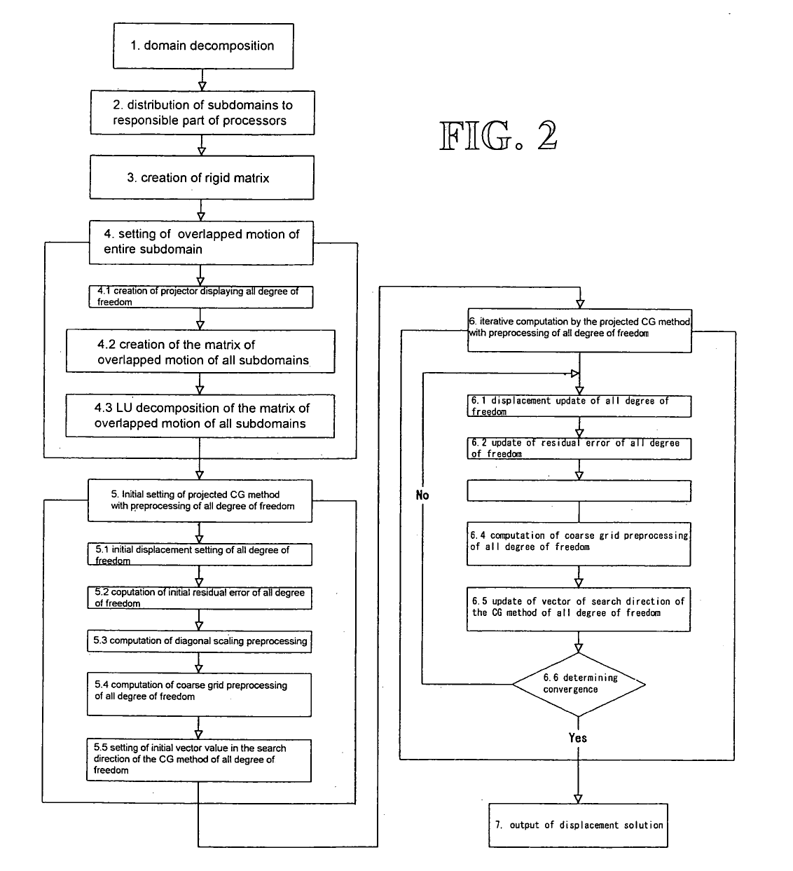

uₙ at the time of convergence of the CG method with preprocessing is set to displacement solution u. Any strain and stress maybe derived from u if needed. This computational procedure is shown in FIG. 2.

[Preferred Embodiment]

The superiority of computing performance of CGCG method over the DDM, parallel CG method, and BDD method will be described with reference to an embodiment. In this embodiment the computing performance of finite element method with a bogie model will be compared. This model includes tetrahedral first order element, 323,639 nodes, 1,123,836 elements, 970,911 degrees of freedom (constrained only 6 degrees of freedom). The computing environment was: four dual Pentium III processors 600 MHz machines, four PEs (one process for each machine) The computing conditions were: the CG method tolerance 1.0*10⁻⁶. The comparison of computing performance is shown in Table 1. From Table 1 one can conclude that the CGCG method has a significantly fewer number of iterative steps and significantly shorter time of computation, in comparison with the DDM and the projected CG method. Although the number of iterative steps of the CGCG method is greater than the BDD method, the computing speed is almost three folds of the BDD method.

TABLE 1

| | | | | memory |
|---|---|---|---|---|
| | | iterative | time | usage |
| Method | subdomains | steps | (minutes) | (MB/PE) |
| CGCG method | 1,600 | 599 | 15 | 167 |
| parallel CG | 4 | 28,565 | 201 | 90 |
| method | | | | |
| DDM | 12,000 | 20,358 | 377 | 167 |
| BDD method | 2,400 | 293 | 40 | 440 |

### EXAMPLE 1

Although the comparison with the DDM with Neumann preprocessing is not listed in Table 1, there are a computing example of the comparison of computing performance of the DDM with that of the DDM with Neumann preprocessing. The computing performance of this example is shown in Table 2. This example used a simplified model made by combining a plurality of rectangular parallelepipeds, which includes tetrahedral second order element, 1,029 nodes, 504 elements, 3,087 degrees of freedom (bottom surface completely immobilized and top suraface forcibly displaced). The computing environment was: one Alpha21164 600 MHz machine, one PE, and the computing conditions were the CG method tolerance of 1.0*10⁻⁷. Table 2 shows the computing time and the number of iterative steps of the DDM and the DDM with Neumann preprocessing. The time saved by the DDM with Neumann preprocessing is approximately 13%, the number saved of iterative steps is at most approximately ½. From this example 1 and the preferred embodiment, the CGCG method in accordance with the present invention is characterized by significantly shorter computation time, in comparison with the DDM, the projected CG method, and the DDM with Neumann preprocessing, which are known in the art as the solutions of a very large scaled structure problem, and by significantly faster computing in comparison with the BDD method, which was developed for the purpose of improved speed and robustness. It can be seen that the number of iterative steps may be even greater than the BDD method, but considerably fewer in comparison with the DDM, the projected CG method and the DDM with Neumann preprocessing. The CGCG method has a very high potential in the computing performance for the solution of very large scaled structure problem.

TABLE 2

| | | Iterative | Computing |
|---|---|---|---|
| Method | Subdomains | steps | time |
| DDM | 12 | 420 | 480 |
| DDM with Neumann | 12 | 240 | 420 |
| preprocessing | | | |

Effects of the Invention

As can be seen from the foregoing, the CGCG method is a finite element method solver algorithm which effectively solves a large scale problem, and is applicable to any analysis based on the finite element method. For example, the method can be applicable to the problems in the field of continuum dynamics, solid dynamics, structure theory, hydrodynamics, thermal conduction theory, and electromagnetics, formulated by the finite element method. In addition, the finite element method can be considered to be a generalized solution of boundary value problem in which the differential equation is the dominant equation, then the CGCG method may be applicable as the solution of boundary value problems in general, in which the differential equation is the dominant equation. In any problems the applied CGCG method is effective for efficiently solving a large scaled problem. The CGCG method may significantly save time in the computation in comparison with the DDM, the projected CG method, and the DDM with Neumann preprocessing, all of which are known in the art as the finite element method solver algorithms for solving a large scaled problem, and also significantly save the number of computational iterative steps.

In addition, the CGCG method is potentially higher performer in comparison with the BDD method, which was developed for accelerating the computation.

1. A parallel finite element method computing system for solving a very large scaled structure problem having the degree of freedom of one million (1,000,000) or more, comprising:
a means for performing domain decomposition;
a means for distributing a subdomain to a responsible part of each processor;
a means for creating a rigid matrix;
a means for defining overlapped movement of entire subdomain;
a means for defining a default setting of projected CG method with preprocessing of all degree of freedom;
a means for performing iterative computation of projected CG method with preprocessing of all degree of freedom; and
a means for outputting a displacement solution.

2. A parallel finite element method computing system set forth in claim 1, in which said means for defining overlapped movement of entire subdomain may further comprise:
a means for creating a projector for displaying all degree of freedom;
a means for creating an overlapped movement matrix of entire subdomain; and
a means for LU decomposing said overlapped movement matrix of entire subdomain.

3. A parallel finite element method computing system set forth in claim 1, in which said means for defining a default setting of projected CG method with preprocessing of all degree of freedom may further comprise:
a means for setting initial displacement of all degree of freedom;
a means for performing computation of initial residual error of all degree of freedom;
a means for performing computation of diagonal scaling preprocessing;
a means for performing computation of coarse grid preprocessing of all degree of freedom; and
a means for defining an initial vector value in the search direction of CG method with all degree of freedom.

4. A parallel finite element method computing system set forth in claim 1, in which said means for performing iterative computation of projected CG method with preprocessing of all degree of freedom may further comprise:
a means for updating the displacement of all degree of freedom;
a means for updating the residual error of all degree of freedom;
a means for performing computation of diagonal scaling preprocessing;
a means for performing computation of coarse grid preprocessing of all degree of freedom;
a means for updating vectors in the search direction of CG method of all degree of freedom; and
a means of determining the convergence.

5. A parallel finite element method computing program used in a parallel finite element method computing system for solving a very large scaled structure problem having the degree of freedom of one million (1,000,000) or more, characterized in that said program operates as
a means for performing domain decomposition;
a means for distributing a subdomain to a responsible part of each processor;
a means for creating a rigid matrix;
a means for defining overlapped movement of entire subdomain;
a means for defining a default setting of projected CG method with preprocessing of all degree of freedom;
a means for performing iterative computation of projected CG method with preprocessing of all degree of freedom; and
a means for outputting a displacement solution,

6. A parallel finite element method computing program set forth in claim 5, in which said means for defining overlapped movement of entire subdomain may further operate as
a means for creating a projector for displaying all degree of freedom;
a means for creating an overlapped movement matrix of entire subdomain; and
a means for LU decomposing said overlapped movement matrix of entire subdomain;

7. A parallel finite element method computing program, set forth in claim 5, in which said means for defining a default setting of projected CG method with preprocessing of all degree of freedom may further operate as
a means for setting initial displacement of all degree of freedom;
a means for performing computation of initial residual error of all degree of freedom;
a means for performing computation of diagonal scaling preprocessing;
a means for performing computation of coarse grid preprocessing of all degree of freedom; and
a means for defining an initial vector value in the search direction of CG method with all degree of freedom;

8. A parallel finite element method computing program, set forth in claim 5, in which said means for performing iterative computation of projected CG method with preprocessing of all degree of freedom may further operate as
a means for updating the displacement of all degree of freedom;
a means for updating the residual error of all degree of freedom;
a means for performing computation of diagonal scaling preprocessing;
a means for performing computation of coarse grid preprocessing of all degree of freedom;
a means for updating vectors in the search direction of CG method of all degree of freedom; and
a means of determining the convergence.

9. A computer readable recording medium having stored thereon a parallel finite element method computing program used in a parallel finite element method computing system for solving a very large scaled structure problem having the degree of freedom of one million (1,000,000) or more, characterized in that said program operates as
a means for performing domain decomposition;
a means for distributing a subdomain to a responsible part of each processor;
a means for creating a rigid matrix;
a means for defining overlapped movement of entire subdomain;
a means for defining a default setting of projected CG method with preprocessing of all degree of freedom;
a means for performing iterative computation of projected CG method with preprocessing of all degree of freedom; and
a means for outputting a displacement solution.

10. A computer readable recording medium having stored thereon a parallel finite element method computing program set forth in claim 9, in which said means for defining overlapped movement of entire subdomain may further operate as
a means for creating a projector for displaying all degree of freedom;
a means for creating an overlapped movement matrix of entire subdomain; and
a means for LU decomposing said overlapped movement matrix of entire subdomain.

11. A computer readable recording medium having stored thereon a parallel finite element method computing program set forth in claim 9, in which said means for defining a default setting of projected CG method with preprocessing of all degree of freedom may further operate as
a means for setting initial displacement of all degree of freedom;
a means for performing computation of initial residual error of all degree of freedom;
a means for performing computation of diagonal scaling preprocessing;
a means for performing computation of coarse grid preprocessing of all degree of freedom; and
a means for defining an initial vector value in the search direction of CG method with all degree of freedom.

12. A computer readable recording medium having stored thereon a parallel finite element method computing program, set forth in claim 9, in which said means for performing iterative computation of projected CG method with preprocessing of all degree of freedom may further operate as
a means for updating the displacement of all degree of freedom;
a means for updating the residual error of all degree of freedom;
a means for performing computation of diagonal scaling preprocessing;
a means for performing computation of coarse grid preprocessing of all degree of freedom;
a means for updating vectors in the search direction of CG method of all degree of freedom; and
a means of determining the convergence.
